(19) United States
(12) Patent Application Publication
(10) Pub. No.: US 2023/0143937 A1
(43) Pub. Date: May 11, 2023

(54) REINFORCEMENT LEARNING WITH INDUCTIVE LOGIC PROGRAMMING

(71) Applicant: INTERNATIONAL BUSINESS MACHINES CORPORATION, Armonk, NY (US)

(72) Inventors: Akifumi Wachi, Tokyo (JP); Songtao Lu, White Plains, NY (US)

(21) Appl. No.: 17/523,553

(22) Filed: Nov. 10, 2021

(51) Int. Cl. B60W 60/00; G06N 3/04; G06K 9/62

(52) U.S. Cl. CPC B60W 60/0016; B60W 60/0011; G06N 3/0481; G06N 3/0454; G06K 9/6297

(57) ABSTRACT

Methods and systems for training a model and automated motion include learning Markov decision processes using reinforcement learning in respective training environments. Logic rules are extracted from the Markov decision processes. T reward logic neural network (LNN) and a safety LNN are trained using the logic rules extracted from the Markov decision processes. The reward LNN and the safety LNN each take a state-action pair as an input and output a corresponding score for the state-action pair.

### BACKGROUND

The present invention generally relates to machine learning systems, and, more particularly, to reinforcement learning systems with safety constraints.

While reinforcement learning can be effectively used to train interactions within a predetermined environment, systems trained with reinforcement learning may have poor performance in environments that were not used for training. In applications where safety is a concern, such poor performance can translate into dangerous operating conditions.

### SUMMARY

A method for training a model includes learning Markov decision processes using reinforcement learning in respective training environments. Logic rules are extracted from the Markov decision processes. T reward logic neural network (LNN) and a safety LNN are trained using the logic rules extracted from the Markov decision processes. The reward LNN and the safety LNN each take a state-action pair as an input and output a corresponding score for the state-action pair.

A method for automated motion includes determining a state of an environment using a sensor on a vehicle. A proposed action is determined, based on the state, using a reward LNN that generates a reward score based on a state-action pair. It is determined that the proposed action is safe, using a safety LNN that generates a safety score based on the state-action pair. The proposed action is automatically performed on the vehicle.

A system for automated motion includes a sensor that collects state information about an environment, a driving system that performs actions in a vehicle, a hardware processor, and a memory that stores a computer program. When executed by the hardware processor, the computer program causes the hardware processor to determine a proposed action, based on the state information, using a reward LNN that generates a reward score based on a state-action pair, to determine that the proposed action is safe, using a safety LNN that generates a safety score based on the state-action pair, and to automatically perform the proposed action using the driving system.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of a vehicle with an automated driving system, in accordance with an embodiment of the present invention;

FIG. 2 is a diagram of an exemplary training environment for an automated driving vehicle, in accordance with an embodiment of the present invention;

FIG. 3 is a block/flow diagram of a method for training an automated driving model using inductive logic programming, in accordance with an embodiment of the present invention;

FIG. 4 is a block/flow diagram of a method for performing automated actions using a constrained Markov decision process (CMDP) model, based on a reward logic neural network (LNN) and a safety LNN, in accordance with an embodiment of the present invention;

FIG. 5 is a block/flow diagram of a method for extracting logic rules from sub-CMDPs, in accordance with an embodiment of the present invention;

FIG. 6 is a block diagram of a computing device that can be used to perform model learning and automated driving, in accordance with an embodiment of the present invention;

FIG. 7 is a block diagram of reinforcement learning with inductive logic programming for learning a model, in accordance with an embodiment of the present invention;

FIG. 8 is a diagram of a neural network architecture, in accordance with an embodiment of the present invention;

FIG. 9 is a diagram of a deep neural network architecture, in accordance with an embodiment of the present invention;

FIG. 10 depicts a cloud computing environment according to an embodiment of the present invention; and

FIG. 11 depicts abstraction model layers according to an embodiment of the present invention.

### DETAILED DESCRIPTION

To help reinforcement learning systems generalize from the environments that they were trained into new environments, inductive logic programming can be used to extract rules from trained models. In addition, a safety constraint may be implemented that limits actions taken by the reinforcement learning system to those actions which are predicted to have a safe outcome. Two models may thus be trained using the inductive logic programming—one that maximizes a reward value and one that imposes a safety constraint.

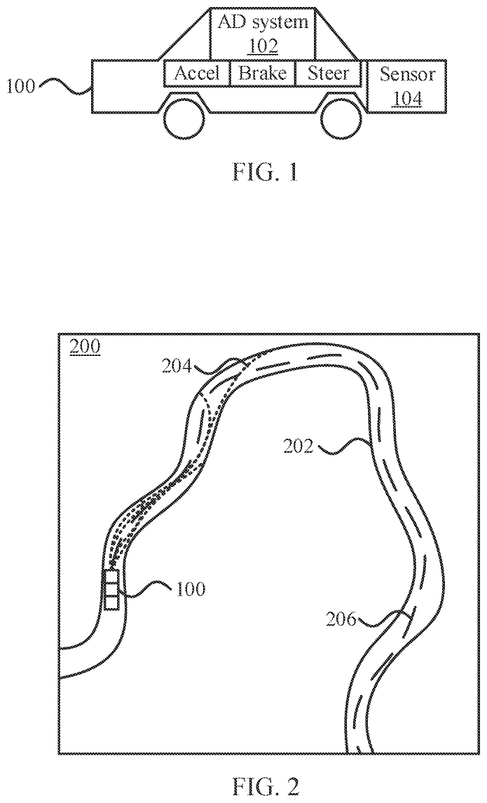

Referring now to FIG. 1, a vehicle 100 with an automated driving system 102 is shown. The automated driving system 102 is used herein as a description of a potential application for a reinforcement learning system, but it should be understood that any appropriate system that operates within an environment can be used instead.

The automated driving system 102 interfaces with various systems in the vehicle 100, including acceleration/throttle systems, braking systems, and steering systems. The automated driving system 102 can furthermore interface with other vehicle systems, for example engaging or disengaging systems such as traction control, four-wheel drive, global positioning satellite receiving, and any other systems relating to navigation and control for the vehicle 100. The automated driving system 102 can be fully autonomous, accepting no driver input, or can be partially autonomous, where only some vehicle systems are controlled or where control can be overridden by a driver.

The systems of the vehicle 100 are limited in terms of their ability to change the vehicle's state. For example, the acceleration and braking systems are limited in the acceleration they can exert on the vehicle 100, and the steering systems are limited in their turning radius and response speed. These different factors dictate how the vehicle 100 can move on the road within a given time period, providing the range of possible actions that the automated driving system 102 can take.

It should be understood that the term “vehicle” is used herein to refer to many different kinds of vehicles, including passenger vehicles and cargo vehicles. It should further be understood that the term “vehicle” is not limited to automobiles and other motorized conveyances, but can also include human-powered vehicles, such as bicycles.

As the vehicle 100 navigates on a roadway, it will encounter a variety of obstacles. Some of these obstacles are fixed in place, such as traffic control devices, while others may be in motion, such as road debris and other vehicles. The vehicle 100 includes one or more sensors 104 that sense the presence of obstacles on the road. The sensors 104 have a certain range, within which they are able to reliably detect the presence of an obstacle. The information from the sensors 104 may be provided as input to the automated driving system 102, which uses them to identify the present state of the vehicle 100 and the environment that it operates within.

Referring now to FIG. 2, an example of reinforcement learning is shown. In this example, a vehicle 100 is given the task of navigating a course 200 along a path 202. In this example, the vehicle 100 may be understood as a robot or a self-driving vehicle, but it should be understood that the present principles apply to any appropriate reinforcement learning application. The vehicle 100 can turn to the left or right to stay within the path 202. The vehicle 100 succeeds at its task if it reaches the end of the path 202, and fails at its task if it intersects with the borders of the path 202 before reaching the end.

In reinforcement learning, the success and failure of the task can be used to inform an automatic driving system 102 within the vehicle 100. The automatic driving system 102 may update its policies to reflect the reward information, for example making the vehicle 100 less likely to perform actions that tend to result in failure, and more likely to perform actions that tend to result in success. In some cases, the reward value may be determined based on a time to reach the destination.

A variety of different trials 204 are shown as dotted lines. As can be seen many such trials 204 may result in failure. These trials 204 may represent unsafe driving conditions. A successful trial 206 is shown that reaches the end of the path 202 without an unsafe condition occurring. Thus, two different functions may be considered: a reward function that judges successful completion of the path and that may be used to compare successful paths 206 in accordance with some criteria (e.g., speed of completion), and a safety function that determines whether a given meets safety criteria.

During training of the automated driving system 102, multiple such environments 100 may be used. Reinforcement learning will learn how to handle each of these environments in a safe and efficient way. However, when using the trained system in new environments, which may have unfamiliar arrangements of obstacles and hazards, the automated driving system 102 may not perform efficiently or safely.

Each training environment may be used to train a respective sub-constrained Markov decision process (CMDP), which may be combined into a general CMDP. A Markov decision process may be used as a reinforcement learning model, with a reward function Qᵣ(s, a) that takes a present state s of the environment 200 and the vehicle 100 and an action a that the vehicle 100 may take within the environment 200. A new state s′ is probabilistically generated, and a reward value is determined for the action. Multiple such actions a may be evaluated, and a best action may be selected in accordance with the reward and the new state s′.

In a CMDP, the Markov decision process is further constrained by a second function, in this case Q_{g}(s, a), which represents a safety criterion. During operation, the highest-reward action a₁ may be determined using the reward function Qᵣ(s, a₁). This action may then be evaluated using the safety function Q_{g}(s, a₁) to determine a safety prediction. If this safety prediction falls below a threshold value, then the action a₁ is rejected, and a next-best action a₂ is evaluated for safety. This process may continue until an action a_{g} is found that can satisfy the safety threshold. The action a_{g} may then be performed by the automated driving system 102 to reach a new state s′.

The CMDP may be represented as:

[symbol]

=< [symbol] , [symbol] , [symbol] , r, g, b, γ, ρ>

where [symbol] is a set of states {s}, [symbol] is a set of actions {a}, [symbol] (s′|s, a) is a state transition function, r: [symbol] × [symbol] →[0,1] is a bounded reward function, g: [symbol] × [symbol] →[0,1] is a bounded safety function, b ∈ [symbol] is a threshold for the safety constraint, γ ∈ [0,1) is a discount factor, and ρ ∈ [symbol] is an initial state distribution. A CMDP with a logical representation may be expressed as:

[symbol]

⁺= [symbol] ∪< [symbol] , [symbol] >

In particular, the term pₛ: [symbol] → [symbol] is a state encoder that maps states s to a set of atoms [symbol] , and the term [symbol] : [symbol] → [symbol] is an action encoder that maps actions a to a set of atoms [symbol] . For all (s, a) ∈ [symbol] × [symbol] , the logical representation of a reward function r̅: [0, 1] [symbol] ×[0,1] [symbol] →[0,1] and the safety function g̅: [0,1] [symbol] ×[0,1] [symbol] →[0,1] can be respectively represented as:

g̅( [symbol] (s), [symbol] (a))=g(s, a)

r̅( [symbol] (s), [symbol] (a))=r(s, a)

which include the following logical operations: ∧ (AND), ∨ (OR), ¬ (NOT), and → (IMPLY).

Each environment 200 that is used for training the automated driving system 102 may generate a respective sub-CMDP. The number of sub-CMDPs is L and subsets [symbol] ᵢ(i=1, 2, . . . , L) are the subsets of the states [symbol] that correspond to each respective sub-CMDP. The sub-CMDP may be expressed as [symbol] ᵢ⁺=< [symbol] ᵢ, [symbol] , [symbol] ᵢ, rᵢ, gᵢ, b, γ, ρ, [symbol] , [symbol] >, where [symbol] ᵢ, rᵢ, and gᵢ are respectively the restrictions of the original [symbol] , r, g to the domain [symbol] ᵢ× [symbol] .

The following optimization problem is used to determine actions in a target environment, which may not have been seen during training:

$${max}_{π} {𝔼}_{{s}_{0} \sim ρ} [ {V}_{r}^{π} ( {s}_{0} ) ] subject to {𝔼}_{{s}_{0} \sim ρ} [ {V}_{g}^{π} ( {s}_{0} ) ] \geq b$$

where Vᵣ^{π} is a value function for a policy π and s₀ is a state.

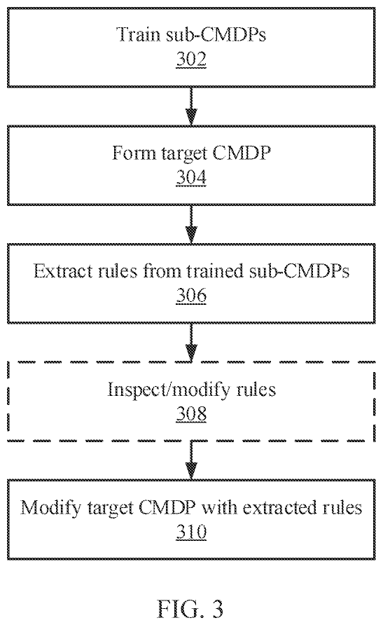

Referring now to FIG. 3, a method of training a machine learning system is shown. Block 302 begins by training sub-CMDPs on respective training environments. This training may be performed using any appropriate reinforcement learning implementation, and may generate respective policies for each training environment. Block 304 may form a target CMDP that can be used in a variety of different environments by connecting the sub-CMDPs into a single hierarchical structure that will select a most appropriate environment's policy when presented with a previously unseen target environment.

Block 306 extracts rules from the trained sub-CMDPs. As will be described in greater detail below, the rules may be extracted using inductive logic programming, such as by using logical neural network (LNN) models. The input to block 306 may include state-action pairs, e.g., ( [symbol] (s), [symbol] (a)), and the output may be the functions Qᵣⁱ(s, a) and q_{g}ⁱ(s, a) for each environment i. The rules may optionally be inspected and modified by a human operator in block 308. The rules from the various sub-CMDPs can be concatenated into a total inductive logic programming reward function,

$${Q}_{r}^{ILP} ( s , a ) = {max}_{i} {Q}_{r}^{i} ( s , a ) ∀ ( s , a ) ∈ ( S , 𝒜 ) ,$$

that selects the action that has the highest reward out of the various sub-CMDPs, and a total inductive logic programming safety function,

$${Q}_{g}^{ILP} ( s , a ) = {min}_{i} {Q}_{g}^{i} ( s , a ) ∀ ( s , a ) ∈ ( S , 𝒜 ) ,$$

that selects the minimum safety score from the various sub-CMDPs. At block 310, the reward function Qᵣ^{ILP}(s, a) may be combined with the target CMDP from block 304, Q(a, s), to generate an action proposal:

$${a}_{1} = {max}_{a ∈ 𝒜} Q ( a , s ) + {Q}_{r}^{ILP} ( a , s ) .$$

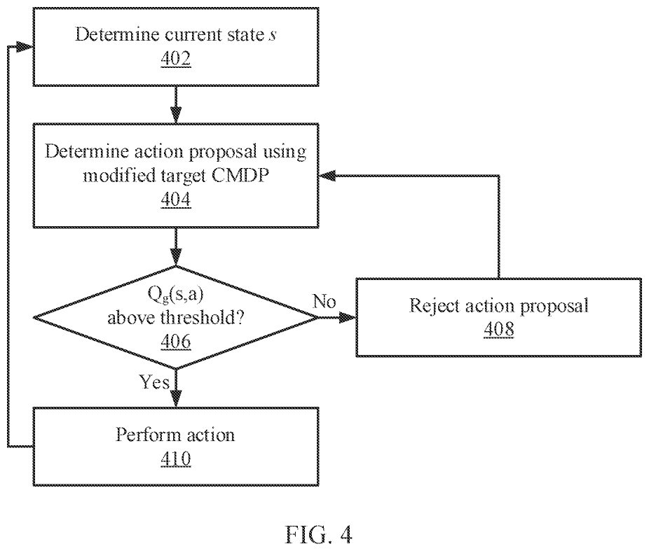

Referring now to FIG. 4, a method of using a trained machine learning system is shown. Block 402 determines the current state s of the agent and the environment. Following the vehicular example above, the state s may include information about the vehicle 100, such as location, speed, and direction, and may further include information about the environment 200, such as detected obstacles, pedestrians, and other vehicles, road conditions, and weather conditions. Block 404 then determines an action proposal

$${a}_{1} = {max}_{a ∈ 𝒜} Q ( a , s ) + {Q}_{r}^{ILP} ( a , s )$$

using the machine learning model described above. This first action proposal will represent the action in [symbol] that generates the highest combined reward value. For example, this may be the action that covers the greatest distance toward a destination.

Block 406 then calculates a value for the safety function Q_{g}^{ILP}(a₁, s), using the action proposal. If this value is not above a predetermined threshold (e.g., Q_{g}^{ILP}≥b), then block 408 rejects the action proposal a₁. Processing returns to block 404, with a new action being proposed from the set of actions, excluding a₁:

$${a}_{2} = {max}_{a ∈ 𝒜 ∖ \{ {a}_{1} \}} Q ( a , s ) + {Q}_{r}^{ILP} ( a , s ) .$$

This process may be repeated any number of times, until an action proposal aₙ passes the safety threshold test of block 406. When this occurs, block 410 performs the action aₙ within the environment. Processing may then return to block 402, to determine the current state that resulted from the action aₙ.

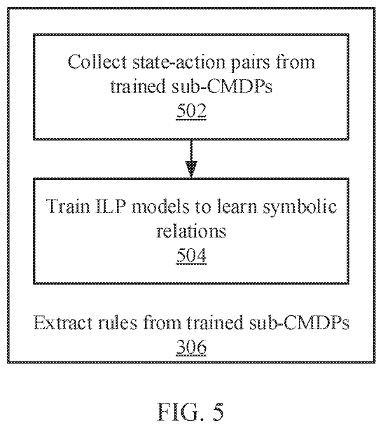

Referring now to FIG. 5, additional information on extracting the rules in block 306 is shown. Block 502 collects state-action pairs from trained the sub-CMDPs. For example, a dataset may be generated as (s, a, Qᵣⁱ(s, a), Q_{g}ⁱ(s, a)) for all i. Block 504 then trains ILP models to learn the symbolic relations that can be extracted from these state-action pairs. It is specifically contemplated that the ILP models may be implemented as LNNs.

As noted above, the LNNs may include AND, OR, NOT, and IMPLY gates. Training of LNNs is done in a manner similar training any other neural network. A loss function for each LNN is defined as a logical contradiction. The following pseudo-code illustrates an exemplary process for training the LNNs:

for I=1, 2, . . . do

generate random sub-CMDPs by extracting internal state spaces [symbol] ᵢ

[symbol] ←logical representation of state in [symbol] ᵢ for sub-CMDP i

Reward LNNᵢ←input: ( [symbol] , [symbol] ), output: Qᵣ

Safety LNNᵢ←input: ( [symbol] , [symbol] ), output: Q_{g}

In general, an LNN may be implemented as a form of recurrent neural network with a one-to-one correspondence to logical formulae in a system of weighted, real-valued logic. Evaluation of the LNN performs a logical inference. When training the LNN, a loss function penalizes logical contradictions. The LNN training process therefore tends to generate a logically consistent system from a training dataset of logic propositions.

For example, the state-action pairs of the sub-CMDPs can be expressed as logical propositions, such as A ∧ B→C, with A and B representing features of a state s and with C representing an action a. In this example, when the state includes the conditions A and B at the same time (e.g., a speed above 50 mpg and a stopped car ahead), then the sub-CMDP would perform the action C (e.g., applying brakes with sufficient force to prevent a collision). Training the LNNs seeks to create a system that will evaluate an input state-action pair in accordance with a goal (e.g., maximizing reward or safety) while maintaining logical consistency of the system.

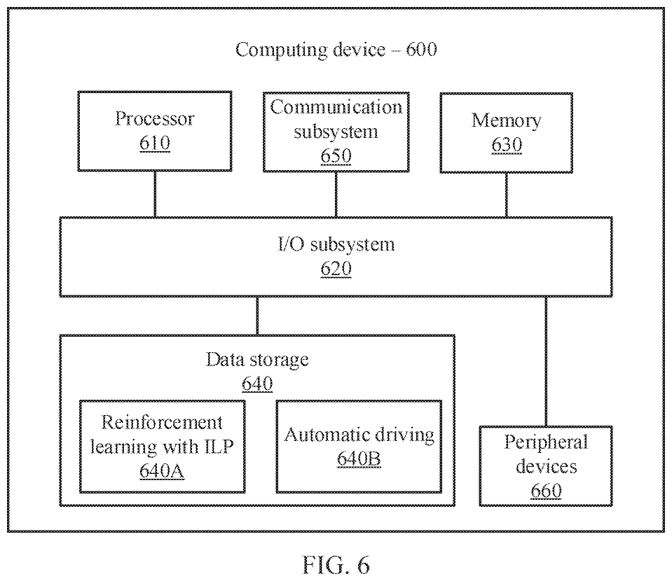

FIG. 6 is a block diagram showing an exemplary computing device 600, in accordance with an embodiment of the present invention. The computing device 600 is configured to generalize from reinforcement learning models to perform a function, such as automated driving.

The computing device 600 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 600 may be embodied as a one or more compute sleds, memory sleds, or other racks, sleds, computing chassis, or other components of a physically disaggregated computing device.

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for reinforcement learning with inductive logic programming and program code 640B for automated driving. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

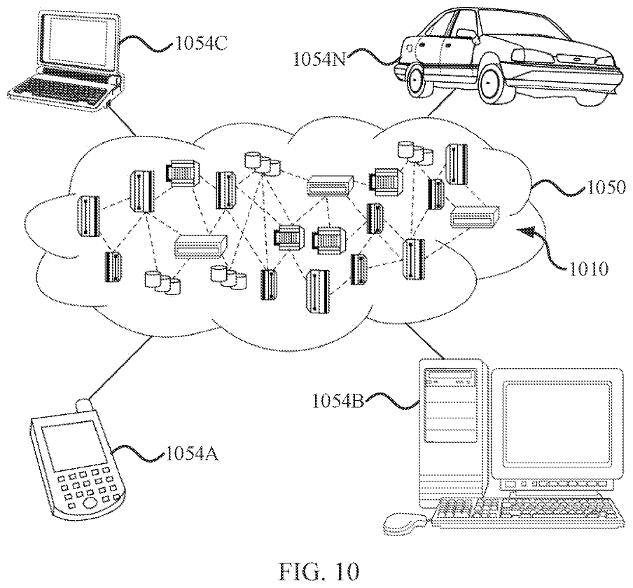

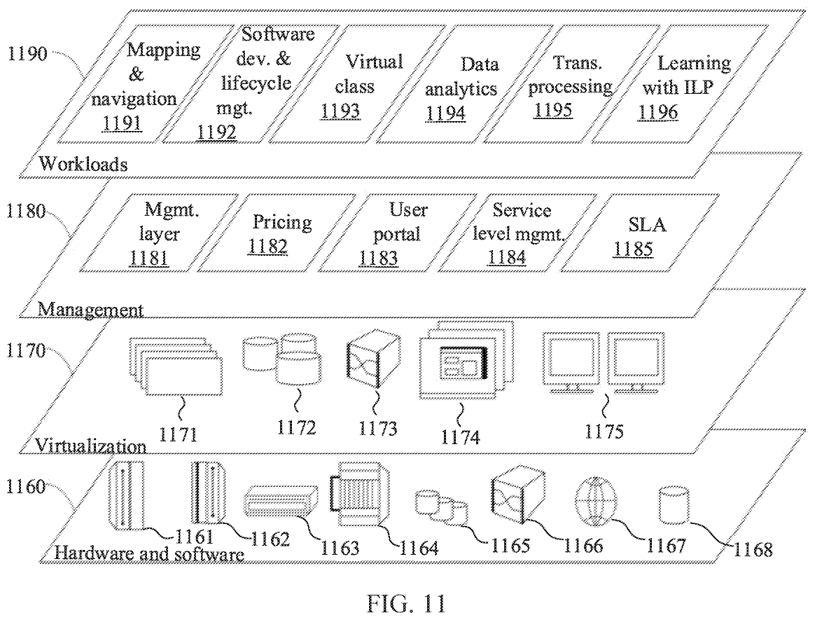

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. Further, in another embodiment, a cloud configuration can be used (e.g., see FIGS. 10-11). These and other variations of the processing system 600 are readily contemplated by one of ordinary skill in the art given the teachings of the present invention provided herein.

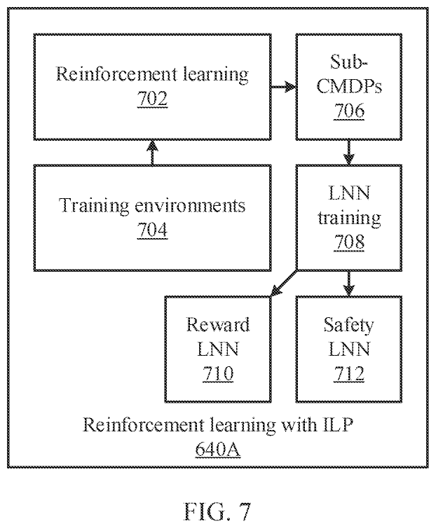

Referring now to FIG. 7, additional detail on the reinforcement learning with ILP 640A is shown. Reinforcement learning 702 uses training environments 704 to generate sub-CMDPs 706. For example, each sub-CMDP 706 may correspond to a different respective training environment 704. LNN training 708 extracts state-action pairs from the sub-CMDPs 706 and uses them to train LNNs, including a reward LNN 710 and a safety LNN 712. These LNNs may be used by other systems, such as automated driving 640B, to inform the performance of actions in an automated system. As noted above, the LNNs may be implemented as a form of recurrent neural network (RNN), with a one-to-one correspondence to a set of logical formulae.

RNNs may be used to process sequences of information, such as an ordered series of feature vectors. This makes RNNs well suited to text processing and speech recognition, where information is naturally sequential. Each neuron in an RNN receives two inputs: a new input from a previous layer, and a previous input from the current layer. An RNN layer thereby maintains information about the state of the sequence from one input to the next.

In an LNN, neural activation functions may be constrained to the logical operations described above, and results may be expressed in terms of bounds on truth values, distinguishing between known states, approximately unknown states, unknown states, and contradictory states. An LNN may be expressed as a graph of syntax trees for all represented formulae, connected to one another via neurons for each proposition. Thus, there may be one neuron for each logical operation occurring in each formula, and one neuron for each unique proposition occurring in any formula.

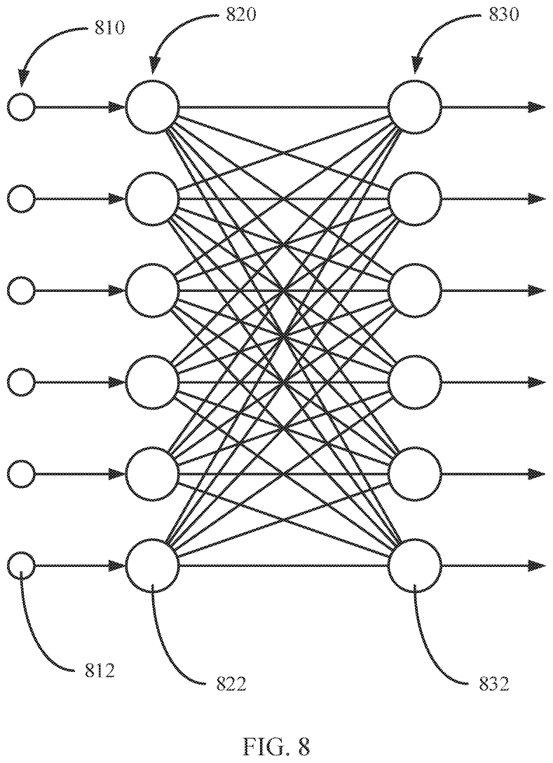

Referring now to FIG. 8, an exemplary neural network architecture is shown. In layered neural networks, nodes are arranged in the form of layers. A simple neural network has an input layer 820 of source nodes 822, a single computation layer 830 having one or more computation nodes 832 that also act as output nodes, where there is a single node 832 for each possible category into which the input example could be classified. An input layer 820 can have a number of source nodes 822 equal to the number of data values 812 in the input data 810. The data values 812 in the input data 810 can be represented as a column vector. Each computational node 830 in the computation layer generates a linear combination of weighted values from the input data 810 fed into input nodes 820, and applies a non-linear activation function that is differentiable to the sum. The simple neural network can perform classification on linearly separable examples (e.g., patterns).

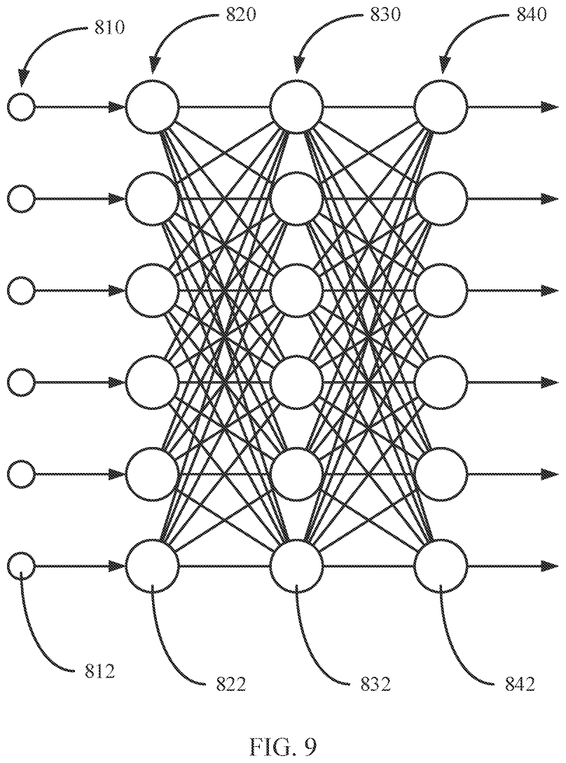

Referring now to FIG. 9, a deep neural network architecture is shown. A deep neural network, also referred to as a multilayer perceptron, has an input layer 820 of source nodes 822, one or more computation layer(s) 830 having one or more computation nodes 832, and an output layer 840, where there is a single output node 842 for each possible category into which the input example could be classified. An input layer 820 can have a number of source nodes 822 equal to the number of data values 812 in the input data 810. The computation nodes 832 in the computation layer(s) 830 can also be referred to as hidden layers because they are between the source nodes 822 and output node(s) 842 and not directly observed. Each node 832, 842 in a computation layer generates a linear combination of weighted values from the values output from the nodes in a previous layer, and applies a non-linear activation function that is differentiable to the sum. The weights applied to the value from each previous node can be denoted, for example, by w₁, w₂, wₙ₋₁ wₙ. The output layer provides the overall response of the network to the inputted data. A deep neural network can be fully connected, where each node in a computational layer is connected to all other nodes in the previous layer. If links between nodes are missing the network is referred to as partially connected.

Training a deep neural network can involve two phases, a forward phase where the weights of each node are fixed and the input propagates through the network, and a backwards phase where an error value is propagated backwards through the network.

The computation nodes 832 in the one or more computation (hidden) layer(s) 830 perform a nonlinear transformation on the input data 812 that generates a feature space. The feature space the classes or categories may be more easily separated than in the original data space.

To train a neural network, training data can be divided into a training set and a testing set. The training data includes pairs of an input and a known output. During training, the inputs of the training set are fed into the neural network using feed-forward propagation. After each input, the output of the neural network is compared to the respective known output. Discrepancies between the output of the neural network and the known output that is associated with that particular input are used to generate an error value, which may be backpropagated through the neural network, after which the weight values of the neural network may be updated. This process continues until the pairs in the training set are exhausted.

After the training has been completed, the neural network may be tested against the testing set, to ensure that the training has not resulted in overfitting. If the neural network can generalize to new inputs, beyond those which it was already trained on, then it is ready for use. If the neural network does not accurately reproduce the known outputs of the testing set, then additional training data may be needed, or hyperparameters of the neural network may need to be adjusted.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 10, illustrative cloud computing environment 1050 is depicted. As shown, cloud computing environment 1050 includes one or more cloud computing nodes 1010 with which local computing devices used by cloud consumers, such as, for example, personal digital assistant (PDA) or cellular telephone 1054A, desktop computer 1054B, laptop computer 1054C, and/or automobile computer system 1054N may communicate. Nodes 1010 may communicate with one another. They may be grouped (not shown) physically or virtually, in one or more networks, such as Private, Community, Public, or Hybrid clouds as described hereinabove, or a combination thereof. This allows cloud computing environment 1050 to offer infrastructure, platforms and/or software as services for which a cloud consumer does not need to maintain resources on a local computing device. It is understood that the types of computing devices 1054A-N shown in FIG. 10 are intended to be illustrative only and that computing nodes 1010 and cloud computing environment 1050 can communicate with any type of computerized device over any type of network and/or network addressable connection (e.g., using a web browser).

Referring now to FIG. 11, a set of functional abstraction layers provided by cloud computing environment 1150 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 1160 includes hardware and software components. Examples of hardware components include: mainframes 1161; RISC (Reduced Instruction Set Computer) architecture based servers 1162; servers 1163; blade servers 1164; storage devices 1165; and networks and networking components 1166. In some embodiments, software components include network application server software 1167 and database software 1168.

Virtualization layer 1170 provides an abstraction layer from which the following examples of virtual entities may be provided: virtual servers 1171; virtual storage 1172; virtual networks 1173, including virtual private networks; virtual applications and operating systems 1174; and virtual clients 1175.

In one example, management layer 1180 may provide the functions described below. Resource provisioning 1181 provides dynamic procurement of computing resources and other resources that are utilized to perform tasks within the cloud computing environment. Metering and Pricing 1182 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1183 provides access to the cloud computing environment for consumers and system administrators. Service level management 1184 provides cloud computing resource allocation and management such that required service levels are met. Service Level Agreement (SLA) planning and fulfillment 1185 provide pre-arrangement for, and procurement of, cloud computing resources for which a future requirement is anticipated in accordance with an SLA.

Workloads layer 1190 provides examples of functionality for which the cloud computing environment may be utilized. Examples of workloads and functions which may be provided from this layer include: mapping and navigation 1191; software development and lifecycle management 1192; virtual classroom education delivery 1193; data analytics processing 1194; transaction processing 1195; and reinforcement learning with ILP 1196.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of reinforcement learning with inductive logic programming (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for training a model, comprising:
learning a plurality of Markov decision processes using reinforcement learning in respective training environments;
extracting logic rules from the plurality of Markov decision processes; and
training a reward logic neural network (LNN) and a safety LNN using the logic rules extracted from the plurality of Markov decision processes, wherein the reward LNN and the safety LNN each take a state-action pair as an input and output a corresponding score for the state-action pair.

2. The method of claim 1, wherein extracting the logic rules includes identifying state-action pairs in the plurality of Markov decision processes and expressing the state-action pairs as logic propositions.

3. The method of claim 1, wherein training the reward LNN includes an objective function that maximizes a reward value while minimizing logical contradictions.

4. The method of claim 1, wherein training the safety LNN includes an objective function that maximizes a safety value while minimizing logical contradictions.

5. The method of claim 1, further comprising combining the plurality of Markov decision processes into a target constrained Markov decision process.

6. The method of claim 1, wherein the reward LNN and the safety LNN are implemented as recurrent neural networks, with neurons representing logical operations and unique propositions.

7. A computer-implemented method for automated motion, comprising:
determining a state of an environment using a sensor on a vehicle;
determining a proposed action, based on the state, using a reward logic neural network (LNN) that generates a reward score based on a state-action pair;
determining that the proposed action is safe, using a safety LNN that generates a safety score based on the state-action pair; and
automatically performing the proposed action on the vehicle.

8. The method of claim 7, wherein determining that the proposed action is safe includes comparing the safety score to a threshold.

9. The method of claim 7, further comprising determining a first action, before determining the proposed action, having a higher reward score than the reward score of the proposed action.

10. The method of claim 9, further comprising determining that the first action has a safety score below the threshold before determining the proposed action.

11. The method of claim 10, wherein determining that the first action has a safety score below the threshold includes identifying a minimum safety score from a plurality of scenarios and comparing the minimum safety score to the threshold.

12. The method of claim 11, wherein the plurality of scenarios each correspond to a distinct environment used in training the reward LNN and the logic LNN.

13. The method of claim 7, wherein the reward LNN and the safety LNN are implemented as recurrent neural networks, with neurons representing logical operations and unique propositions.

14. A system for automated motion, comprising:
a sensor that collects state information about an environment;
a driving system that performs actions in a vehicle;
a hardware processor;
a memory that stores a computer program, which, when executed by the hardware processor, causes the hardware processor to:
determine a proposed action, based on the state information, using a reward logic neural network (LNN) that generates a reward score based on a state-action pair;
determine that the proposed action is safe, using a safety LNN that generates a safety score based on the state-action pair; and
automatically perform the proposed action using the driving system.

15. The system of claim 14, wherein the computer program further causes the hardware processor to compare the safety score to a threshold.

16. The system of claim 14, wherein the computer program further causes the hardware processor to determine a first action, before determining the proposed action, having a higher reward score than the reward score of the proposed action.

17. The system of claim 16, wherein the computer program further causes the hardware processor to determine that the first action has a safety score below the threshold before determining the proposed action.

18. The system of claim 17, wherein the computer program further causes the hardware processor to identify a minimum safety score from a plurality of scenarios and comparing the minimum safety score to the threshold.

19. The system of claim 18, wherein the plurality of scenarios each correspond to a distinct environment used in training the reward LNN and the logic LNN.

20. The system of claim 14, wherein the reward LNN and the safety LNN are implemented as recurrent neural networks, with neurons representing logical operations and unique propositions.
